(19) United States
(12) Patent Application Publication
(10) Pub. No.: US 2009/0006478 A1
(43) Pub. Date: Jan. 1, 2009

(54) Days and Visits to Transaction Metrics System and Method

(75) Inventors: Sonya Rikhtverchik, Mountain View, CA (US); Dmitry Faradjev, Mountain View, CA (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 12/146,282

(22) Filed: Jun. 25, 2008

Related U.S. Application Data
(60) Provisional application No. 60/946,047, filed on Jun. 25, 2007.

(51) Int. Cl. G06F 17/30

(52) U.S. Cl. 707/104.1; 707/E17.009

(57) ABSTRACT

A system and method for tracking and reporting days and visits to an online transaction is described. A web analytic system receives web site visit tracking information from a client computer as a user navigates the web site. The system updates a reporting database with visit information. The system may receive data in the form of a report message sent from a site, where the data has been calculated to give the metric or where the message provides the raw data required to derive the metric. The system generates a variety of reports showing time between visits and transactions, such as time between visits, orders, downloads, form completion or other such transactions.

This application claims the benefit of U.S. Provisional Application No. 60/946,047 filed 25 Jun. 2007, entitled “Days and Visits to an Order System and Method,” which is incorporated herein by reference.

### FIELD OF THE INVENTION

The present invention relates to web page statistical reporting. In particular, it relates to data gathering and reporting techniques for web sites.

### BACKGROUND OF THE INVENTION

The World Wide Web (web) has rapidly become an invaluable tool to individuals and businesses. Not only can an individual or business post information on the web, but it can also use the web to transact business. Because the public is acutely aware of the web's business and personal benefits, millions of web pages are being added to the web each year.

Typically, a web page is defined by a document containing Hyper Text Markup Language (HTML) code. An HTML document suitable for posting on the internet includes both “content” and “markup.” The content is information which describes a web page's text or other information for display or playback on a computer's monitor, speakers, etc. The markup is information which describes the web page's behavioral characteristics, such as how the content is displayed and how other information can be accessed via the web page.

In order to provide web-based information and services over the internet, the web employs “client” computers, “browser” software, and “server” computers. A client computer is a computer used by an individual to connect to the internet and access web pages. A browser is a software application, located on a client computer, which requests, via the internet, a web page from a server computer. After receiving the web page, the browser displays the web page on the client computer's monitor. A server computer is a computer which stores web page information, retrieves that information in response to a browser's request, and sends the information, via the internet, to the client computer. Thus, after a web page is created, the page should be “posted” to a particular server computer which “hosts” the page, so that the page can be accessed over the internet.

One web-based service that has seen steady growth in the past decade is e-commerce. The percentage of sales made over the internet continues to grow by double-digits annually. With an adjusted retail sales value of over $36 billion dollars in the fourth quarter of 2007, the percentage of retail sales conducted over the internet increased nearly 5% over the same period the previous year, and accounted for 3.5% of total retail sales in 2007.

With this kind of opportunity for online sales, web merchants are anxious to learn how to leverage the benefits of e-commerce to maximize their own sales. Many web merchants utilize a web analytic system in an effort to gain some understanding of their visitor's behavior. The majority of the functionality offered by these systems is session-related visitor behavior. However, understanding how the visitors behave over a period of time or across sessions can provide valuable information and insight to the merchant.

The present invention provides a solution to these needs and other problems, and offers other advantages over the prior art.

### BRIEF SUMMARY OF THE INVENTION

In a preferred embodiment of the contemplated invention, a web analytic tracking system with reporting module that tracks and reports user/customer visits before a transaction and number of days since the last transaction is described. In this embodiment, client logic in scripts downloaded to the customer's computing device on his first visit to a site calculates visits and days since the last order. These values are set in a persistent cookie planted by the e-commerce system the first time the customer visits the site. The actual calculated visits and days since last order are sent to the web analytic system in report message fields and parameters whenever an order is placed. The data is then available for reporting, use in module or functionality available in the web analytic system, and export to other systems.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is an illustration of process flow for a preferred embodiment of the described invention.

FIG. 2 is a diagram of a web analytics system designed to collect and report web analytics for web sites.

FIG. 3 is diagram of exemplary report messages sent and received by an end-user/client's system.

FIG. 4. is an exemplary report message structure for a client message.

FIG. 5 is an exemplary report message structure for a hint server message segment.

FIG. 6 is an exemplary report message structure for a prediction engine message segment.

FIG. 7 is a screenshot of an exemplary visits to order report.

FIG. 8 is a screenshot of an exemplary days to order report.

### DETAILED DESCRIPTION

One indicator of the success of the online merchants e-commerce system is the number of visits or days it takes before the user performs an action (such as making a purchase) and how long it takes, if at all, before the customer comes back and performs another action. Tracking this information gives the web site owner insight into the behavior of users/visitors to and at the site and helps to understand what actually leads the visitor to perform the desired transaction. These metrics can indicate how many or what portion of customers buy on the first visit, or how many or what portion need several visits in order to transact. The metrics may also indicate how long it takes for a customer to come back for another transaction; or, when used in combination with additional purchase data, which products might lead to a future purchase of other products. Although the following description refers to e-commerce purchase tracking, it will be apparent to those skilled in the art that these metrics may apply equally as well to any type of measurable activity, such as a download or a form completion or registration.

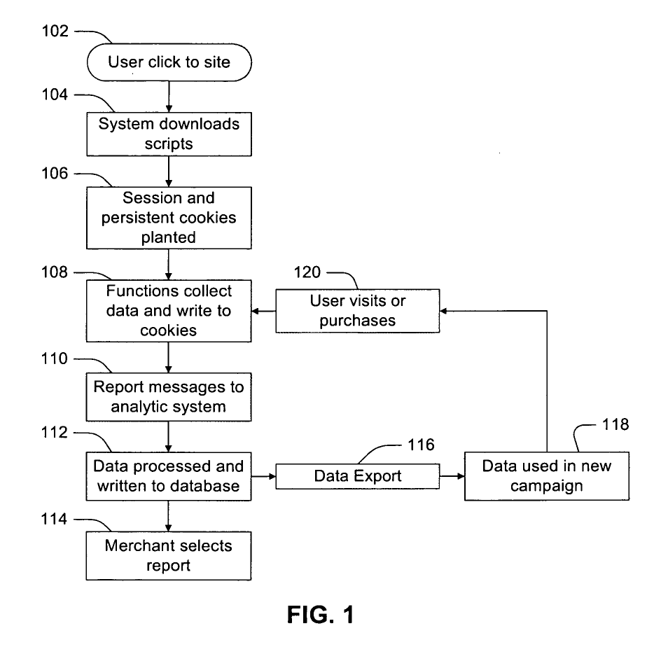

In a preferred embodiment of the contemplated invention, a web analytic system with an e-commerce tracking module and reporting manager tracks user behavior at a target web site (i.e., a visit metric) including, among other things, number of visits to order and number of days to order, FIG. 1 illustrates the process contemplated for a preferred embodiment of this invention. When a user enters the target site 102, the click initiates a download of scripts 104 that plant session and persistent cookies 106 on the user's computer related to the target's web site. A session cookie is used for storage of state between page views within a session, and a persistent cookie is used for keeping user state between visits to a merchant's web site. User behavior data is collected as the user navigates the site and performs transactions 108. As the user moves through the site, the cookies send the user data to the web analytic system 110. The data is parsed, processed and written to a database 112. Merchants may view the data by accessing the reporting module 114. Additionally, data may be exported 116 to other systems for use in marketing campaigns. For instance, a merchant may export the data to an e-mail marketing system and use it in segmenting data for use in configuring a new marketing campaign 118. As the user continues to visit the site 120, new statistics are calculated and returned to the analytic system, allowing the merchant to view reports showing the behavior of the individual user across multiple sessions.

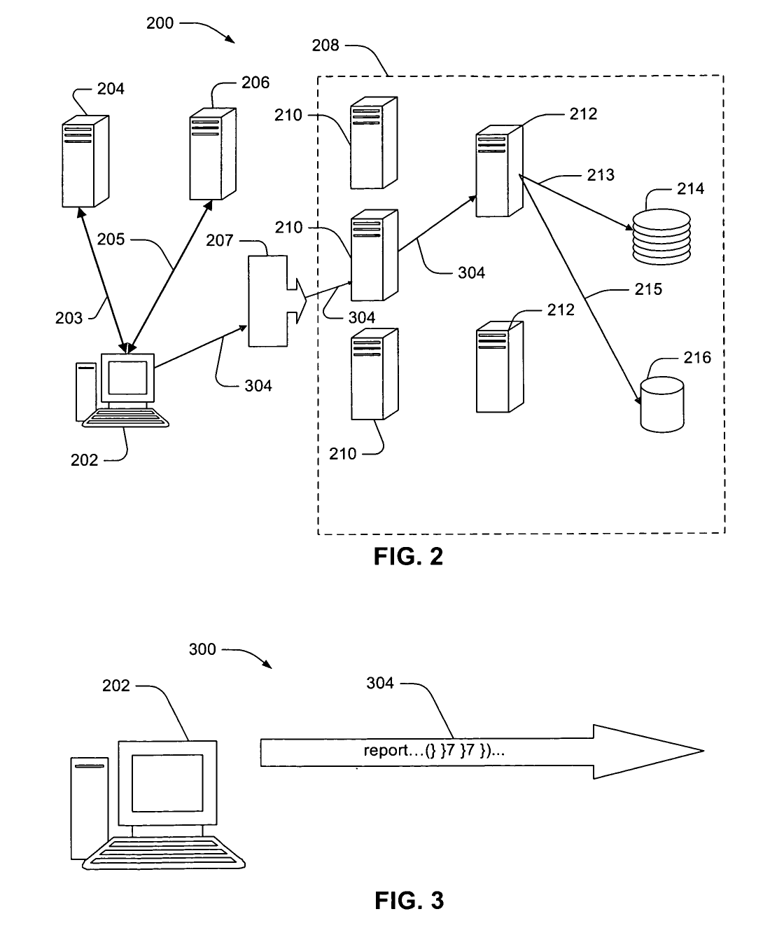

FIG. 2 illustrates an exemplary web analytics system. The web analytics system 208 uses software code operating on the merchant web site 204 or content server 206 to load scripts 203, 205 that plant cookies designed to collect information and keep state about the end-user. This information is transmitted in a report message 304 from session and persistent cookies written to the end-user/client's system 202 to the web analytics hint servers 210 when the user moves from page to page. The client-side (e.g., client 202) generates a session ID on entry to a site such as web site 204. The client-side collects and stores page attributes, such as URL, referrer and title, and computes page timing statistics, such as display time, read time, and connection type (depending on the browser used). Additional functionality on the client side includes computation of session-level attributes, gathering end-user system information, collecting e-commerce actions, gathering custom data from cookies or URL parameters, or custom javascript variables, and performing form tracking. Computations may include frequency values, such as visits to order and days to order

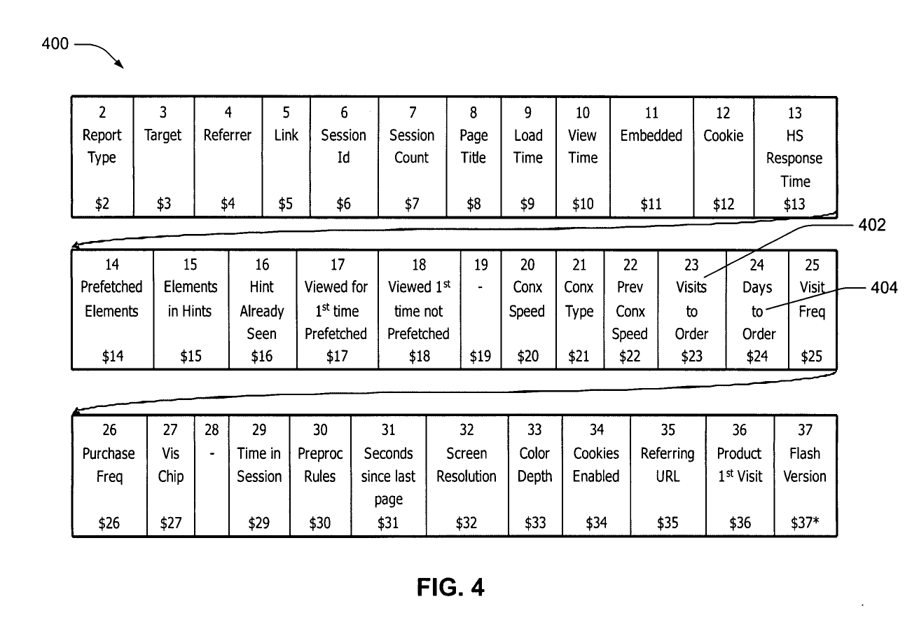

The information gleaned from the client side is contained in a report message 304, 400, an indexed string of delimited data that is sent from the client side 202 to the analytic system at point 207 in FIG. 2. An example of a client portion of a report message structure 400 showing the segments delivering this information 402, 404, 406, 408 is displayed in FIG. 4. The visits to order segment 402 displays the number of user visits that have passed before an order was made. If a user has never purchased in the past, visits is calculated from first visit to the site. If the user is a repeat purchaser, then the number of visits is based on last order placed. Days to order 404 displays the number of days that have passed before an order was made. If a user has never purchased in the past, days is calculated from first visit to the site. If the user is a repeat purchaser, then the number of days is based on last order placed. The report message is passed on to the hint server 210. Although a preferred embodiment of this invention may perform calculations on the client side, those skilled in the art will recognize that it is also possible to gather the data on the server-side by a content provider such as a merchant, and the data may be sent in either raw or derived form.

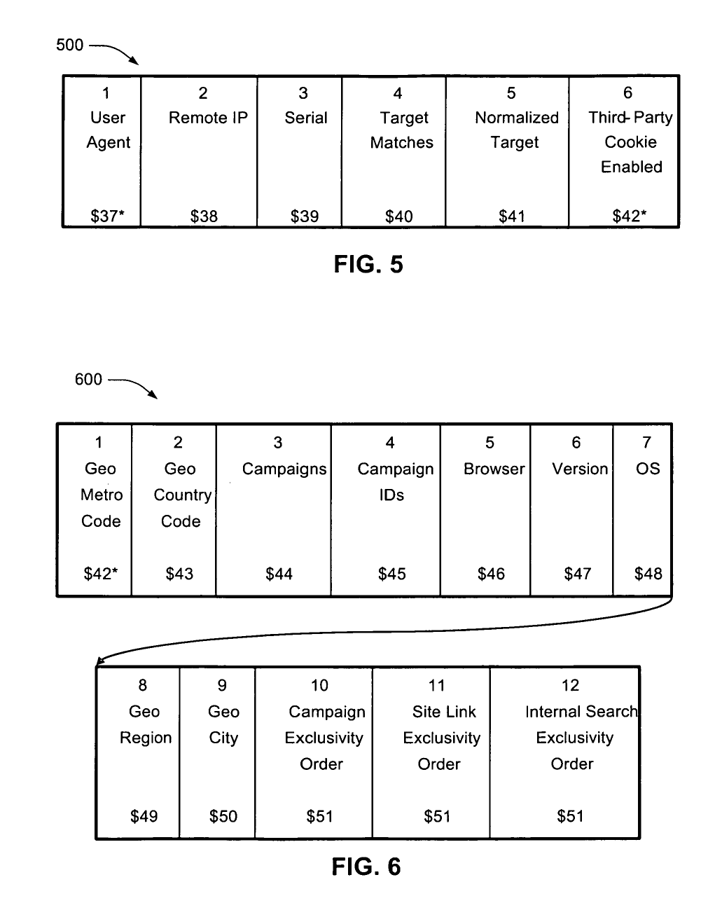

As the report message 404 passes through the hint server 210, the hint server 210 appends additional fields to the report message 500 (shown in FIG. 5) and passes the amended report message to the PE 212. The PE 212 adds its own set of values 600 as shown in FIG. 6 after processing, and the entire message is archived in a log file in the NFS 213, 214 and written to the reporting database 215, 216, 112. An exemplary final message is shown in Table 1 below.

TABLE
!1162411200900′3/u/}1}http://www.hotels.com/promotion.
jsp?id=1105}http://www.hotels.com/promotion.jsp?id=354
8}}C1850307181R3}11}tSan Francisco, CA hotels - Hotel
Reservations & Discounts for Luxury and Budget }1}15}}
}}}}}}}}}2}}2}8}2}1}vis=m53z0#m55z0#m42z0#m52z1#m53z1#
m54z1#m51z2#137#m41z1#m54z2#m36z1#m56z2#m55z2#m40z1#15
2#117#131#m42z1#e125482z#m11z1#m36z0#g440958#m52z2#m53
z2#m35z0#g435236#g405989#m11z0#m40z0#g440959#g405992#g
40590#115}true}}}16}1024×768}32}1}}1}8′Mozilla/4.0
(compatible; MSIE 6.0; Windows NT 5.1; SV1; .NET CLR
1.1.432) }198.189.184.127}hotelsfbmn}115}http: //www.ho
tels.com/promotion.jsp?id=1105}false′}}701, 704, 128, 239,
5852}405989, 405992, 435236, 409590, 125482}0}3}5}}}}}}

In a preferred embodiment, days and visits to order data contained in the report are calculated on the client side, and reach the analytic system with no need for further processing. To accomplish this, a preferred embodiment of the invention utilizes functions contained in scripts downloaded 104, 106 to the client when the client first visits the site 102. If a user has never purchased in the past, visits and days are calculated from the first visit to the site. If the user is a repeat purchaser, then the number of visits/days may be based on last order placed. For example, Joe started visiting a merchant's specialty store on May 2, but didn't buy anything. He visited again on May 5 and on May 12 he purchased a bottle of wine. He visited the site again on May 16, May 18 and May 20. Finally, on May 20 he bought some caviar. The days to order for the May 12 order is 10, and the visits to order is 2. The days to order for the May 20 order is 8, and the visits to order is 3. The values are set in a persistent cookie and will be used next time the order comes in. The system stores the sequential visit number in which the last order was placed and it also stores the timestamp of the last order. The actual calculated or derived visits and days since last order are sent in report message fields and parameters whenever a new order is placed. It will be appreciated by those skilled in the art that a server-side content system (e.g., a merchant web site) may be configured to generate the tracking information message and sent to the analytic system. In addition, the analytic system could retrieve previous visit data from a data store and associate the previous visit data with the received tracking information message when the received information message includes transaction data but incomplete data related to the previous target web site visit.

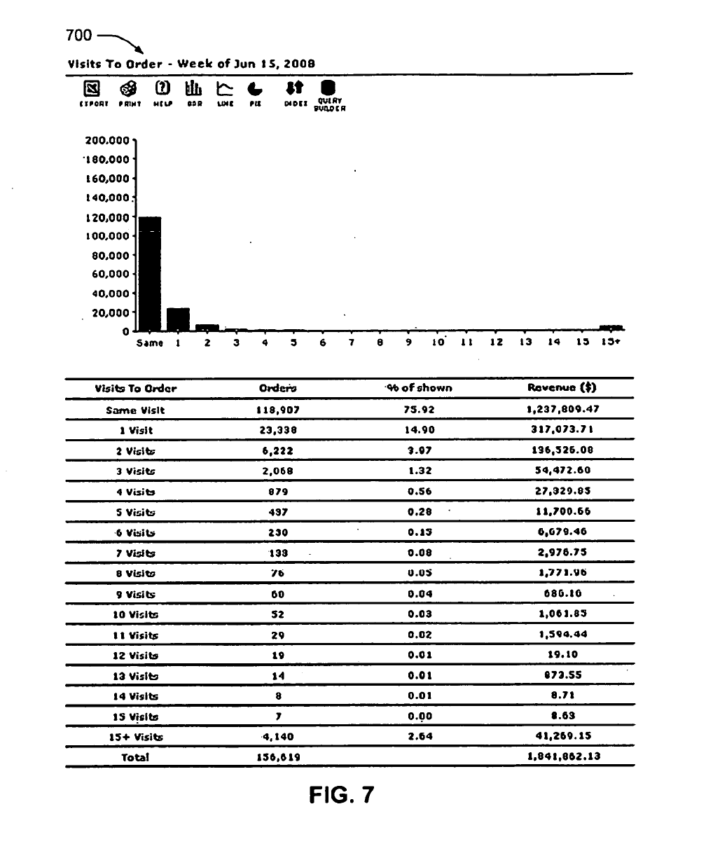

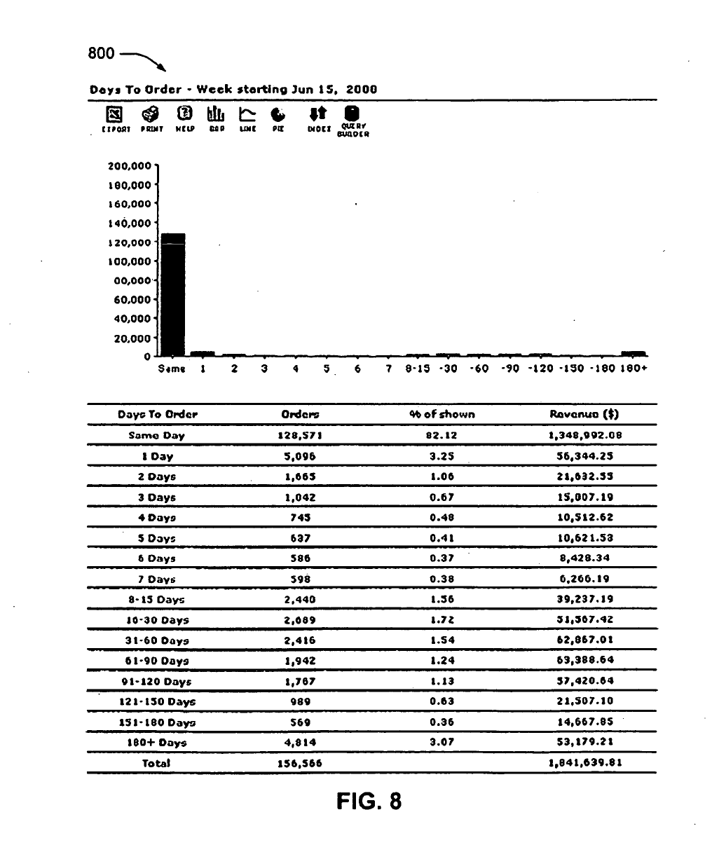

The reports generated from this data provide merchants with invaluable information. With a days to order or visits to order report, the merchant can measure the return generated from specific types of content or offers posted to the site or between types of campaigns (e.g. pay per click, direct traffic, affiliate marketing traffic) and determine the best time to initiate further campaigns. FIGS. 7 and 8 (designated 700 and 800, respectively) are screenshots of exemplary transaction reports. These reports give the merchant invaluable insight into user or customer behavior. For instance, referring to FIG. 7 700, the report may indicate to the merchant that 76% of customers purchase on their first visit, but the remaining 24% will purchase on their next or later visit. Three percent of those will purchase after visiting more than 15 times. The merchant can then segment the data or drill down to determine valuable insights, such as who belongs to each group, what products are purchased only after more thoughtful decision making, or whether there is seasonal variation. FIG. 8 illustrates an exemplary days to order 800 report.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A method for gathering information through a network about user visits to a web site, the method comprising steps of:
receiving a tracking information message from a client computing device, the message including transaction data and data related to a target web site visit as well as a previous target web site visit;
updating a reporting database with a visit metric that has been derived from the data related to the target web site visit as well as the previous target web site visit; and
generating a report based on the visit metric.

2. The method of claim 1 wherein the receiving step comprises receiving the visit metric as the data related to the target web site visit as well as the previous target web site visit.

3. The method of claim 1 further comprising a step of calculating the visit metric based on the received data related to the target web site visit as well as the previous target web site visit.

4. The method of claim 3 wherein the receiving step comprises receiving a timestamp as the data related to the target web site visit as well as the previous target web site visit, and the calculating step comprises utilizing the timestamp in calculating the visit metric.

5. The method of claim 1 wherein the visit metric comprises a number of visits to order.

6. The method of claim 1 wherein the visit metric comprises a number of days to order.

7. The method of claim 1 wherein the transaction data comprises sales order information.

8. The method of claim 1 further comprising retrieving previous visit data from a server-side analytics system and associating the previous visit data with the received tracking information message when the received information message includes transaction data but incomplete data related to the previous target web site visit.

9. The method of claim 1 further comprising a step of generating the tracking information message by utilizing a client-side script at the client computing device.

10. The method of claim 1 further comprising a step of generating the tracking information message by utilizing a server-side content system to generate the tracking information message based on activities associated with the client computing device.

11. A system for gathering information through a network about user visits to a web site, comprising:
an analytic system operatively coupled to a client computing device through the network to receive a tracking information message, the message including transaction data and data related to a target web site visit as well as a previous target web site visit, the analytic system being operatively configured to update a visit metric in a reporting database, the visit metric being derived from the data related to the target web site visit as well as the previous target web site visit; and
a report generator module operatively configured to generate a report based on the visit metric.

12. The system of claim 11 wherein the message comprises the visit metric.

13. The system of claim 11 wherein the analytic system is operatively configured to calculate message the visit metric based on the received data related to the target web site visit as well as the previous target web site visit.

14. The system of claim 13 wherein the data related to the target web site visit as well as the previous target web site visit comprises a timestamp, and the analytic system is operatively configured to utilize the timestamp in calculating the visit metric.

15. The system of claim 11 wherein the visit metric comprises a number of visits to order.

16. The system of claim 11 wherein the visit metric comprises a number of days to order.

17. The system of claim 11 wherein the transaction data comprises sales order information.

18. The system of claim 11 wherein the analytic system is operatively configured to retrieve previous visit data from a data store and to associate the previous visit data with the received tracking information message when the received information message includes transaction data but incomplete data related to the previous target web site visit.

19. The system of claim 11 wherein the client computing device comprises a client-side script which generates the tracking information message.

20. The system of claim 11 further comprising a content provider system, the content provider system comprises a server-side module which generates the tracking information message based on activities associated with the client computing device.
